(19) United States
(12) Patent Application Publication
(10) Pub. No.: US 2023/0319744 A1
(43) Pub. Date: Oct. 5, 2023

(54) SIDELINK SYNCHRONIZATION SIGNAL BLOCK BASED SIDELINK RESOURCE DETERMINATION

(71) Applicant: QUALCOMM Incorporated, San Diego, CA (US)

(72) Inventors: Chih-Hao LIU, San Diego, CA (US); Jing SUN, San Diego, CA (US); Yisheng XUE, San Diego, CA (US); Xiaoxia ZHANG, San Diego, CA (US)

(21) Appl. No.: 17/711,913

(22) Filed: Apr. 1, 2022

(51) Int. Cl. H04W 56/00; H04W 72/04

(52) U.S. Cl. CPC H04W 56/0015; H04W 72/044; H04W 92/18

(57) ABSTRACT

Certain aspects of the present disclosure provide techniques for determining sidelink resources, based on sidelink synchronization signals. According to certain aspects, a method of wireless communication by a first user equipment (UE) generally includes receiving a sidelink synchronization signal block (S-SSB) transmitted in a reference subband, determining, based on the S-SSB, a resource block (RB) set for receiving sidelink transmissions from at least one other UE, and monitoring the RB set for sidelink transmissions from the at least one other UE.

### BACKGROUND

### Field of the Disclosure

Aspects of the present disclosure relate to wireless communications, and more particularly, to techniques for determining sidelink resources, based on sidelink synchronization signals.

### Description of Related Art

Wireless communications systems are widely deployed to provide various telecommunications services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a first user equipment (UE), including receiving a sidelink synchronization signal block (S-SSB) transmitted in a reference subband; determining, based on the S-SSB, a resource block (RB) set for receiving sidelink transmissions from at least one other UE; and monitoring the RB set for sidelink transmissions from the at least one other UE.

One aspect provides a method for wireless communication by a transmitter UE, including transmitting a S-SSB transmitted in a reference subband; determining, based on the S-SSB, a RB set for sidelink transmissions to at least one other UE; and transmitting, using one or more RBs in the RB set, sidelink transmissions to the at least one other UE.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIGS. 5A-5B depict diagrammatic representations of example vehicle-to-everything (V2X) systems.

FIG. 6 depicts example subchannels and slots.

FIG. 7 depicts example reservation of resource for a sidelink transmission via a sidelink control information (SCI).

FIG. 8 depicts example resource block (RB) set configurations.

FIG. 9 depicts a call flow diagram for sidelink resource determination in accordance with aspects of the present disclosure.

FIG. 10 depicts a call flow diagram for sidelink resource determination in accordance with aspects of the present disclosure.

FIG. 11 depicts a method for wireless communications.

FIG. 12 depicts a method for wireless communications.

FIG. 13 depicts aspects of an example communications device.

FIG. 14 depicts aspects of an example communications device.

### DETAILED DESCRIPTION

Aspects of the present disclosure provide apparatuses, methods, processing systems, and computer-readable mediums for determining sidelink resources, based on sidelink synchronization signals.

One challenge for devices attempting to communicate on a wireless medium is how the devices can determine time and frequency resources available for the communications. To prevent the devices from extensive searching, which would consume excessive power and result in substantial latency, the universe of available resources is typically limited in some manner to sets of candidate resources.

As an example, devices in new radio (NR) systems, typically perform initial access by searching for synchronization signal blocks (SSBs) according to a synchronization raster. The synchronization raster generally indicates the frequency positions of the SSBs used by a user equipment (UE) for system acquisition. In other words, the synchronization raster reduces search complexity by indicating a limited number of frequency positions a UE must monitor for SSBs.

From the synchronization raster, a UE is able to find fields in an SSB conveyed physical broadcast channel (PBCH) that points to a common resource block (RB) grid to obtain UE-specific configuration information for additional resources for subsequent communications after the UE is connected to the network. For example, a UE may be configured with a downlink bandwidth part (BWP) and uplink BWP.

Unfortunately, there is currently no such procedure to determine resources for sidelink (SL) communications between UEs. Instead, current systems rely on offline configuration of UEs or network-signaled configuration (e.g., based on signaling from a network entity such as a gNB) that configures the SL resources. While sidelink SSBs (S-SSBs) may be transmitted, S-SSBs are typically only used to provide timing (e.g., system frame number SFN and slot index) and time division duplexed (TDD) configuration information.

Aspects of the present disclosure, however, provide mechanisms that may help UEs determine sidelink resources based on sidelink synchronization signals. The techniques described herein may allow SL UEs to determine a resource block (RB) grid and RB set definition in unlicensed spectrum, based on received S-SSBs. The techniques presented herein may enable SL UEs to efficiently determine resources available for SL resources without excessive searching, thus reducing corresponding latency and power consumption.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

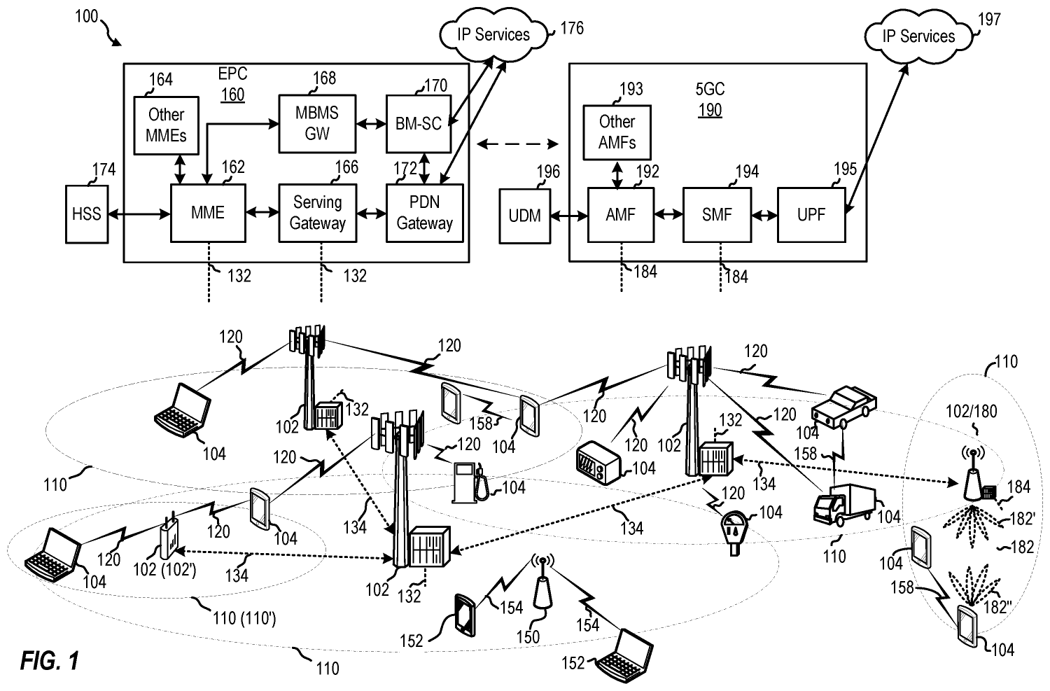

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

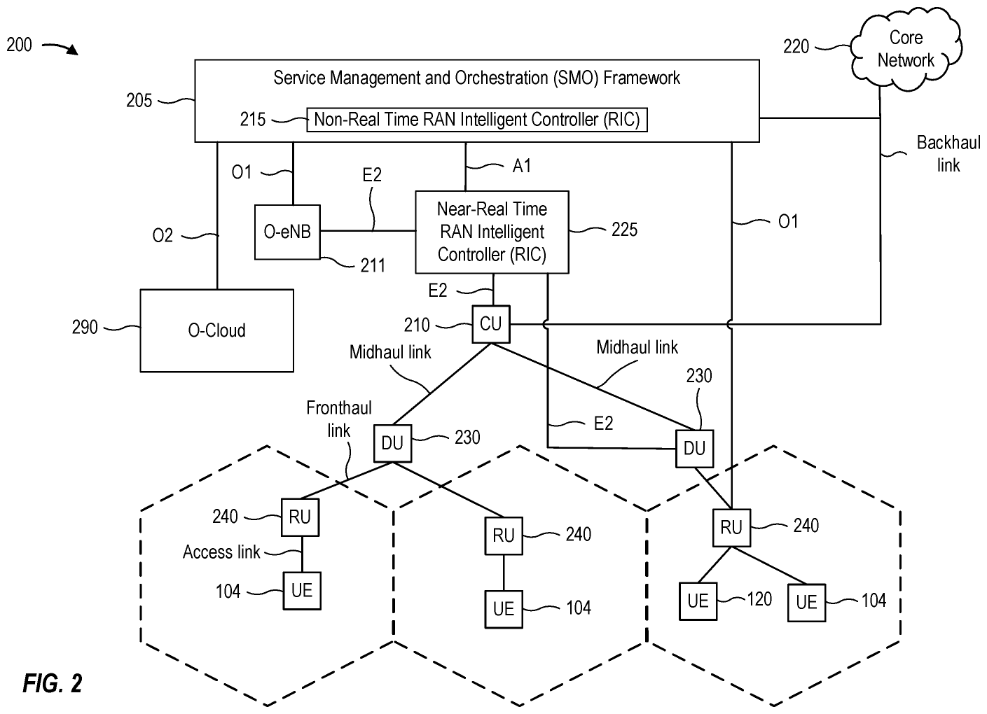

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHz-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. BS 180 may also receive the beamformed signal from UE 104 in one or more receive directions 182′. Base station 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (MC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT MC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

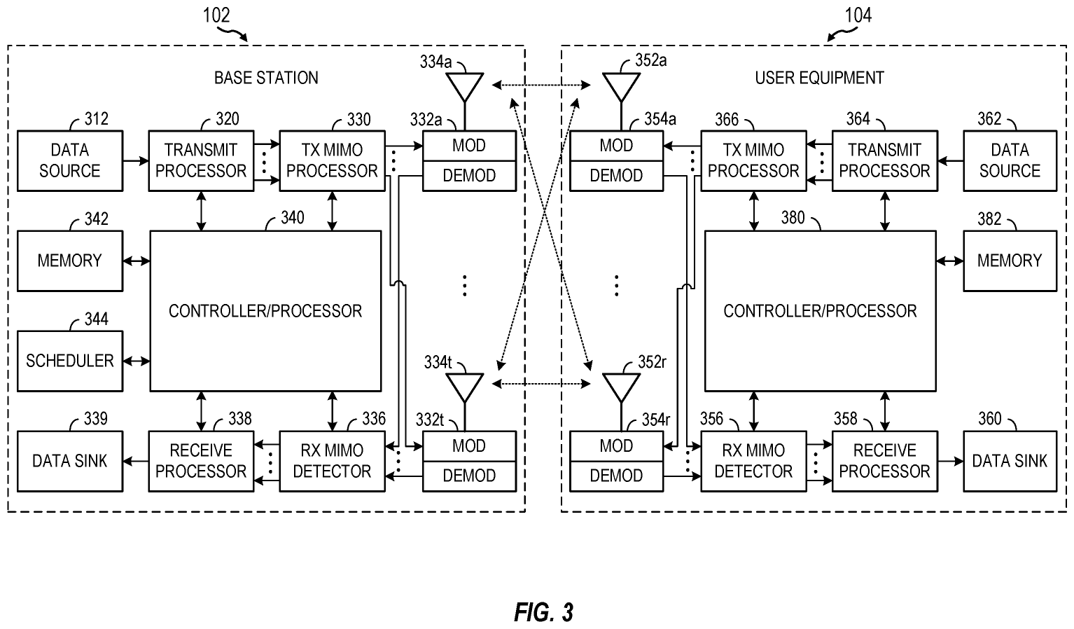

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

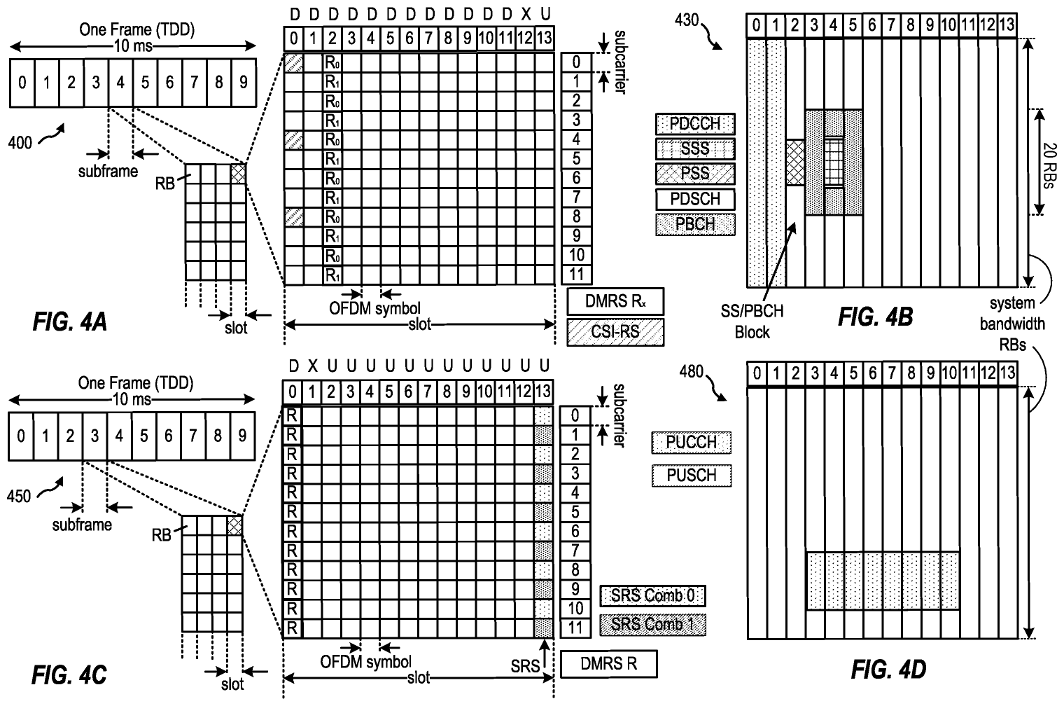

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Sidelink Communication

User equipments (UEs) communicate with each other using sidelink signals. Real-world applications of sidelink communications may include UE-to-network relaying, vehicle-to-vehicle (V2V) communications, vehicle-to-everything (V2X) communications, Internet of Everything (IoE) communications, IoT communications, mission-critical mesh, and/or various other suitable applications.

A sidelink signal refers to a signal communicated from one UE to another UE without relaying that communication through a scheduling entity (e.g., UE or a network entity), even though the scheduling entity may be utilized for scheduling and/or control purposes. In some examples, the sidelink signal is communicated using a licensed spectrum (e.g., unlike wireless local area networks, which typically use an unlicensed spectrum). One example of sidelink communication is PC5, for example, as used in V2V, long term evolution (LTE), and/or new radio (NR).

Various sidelink channels are used for sidelink communications, including a physical sidelink discovery channel (PSDCH), a physical sidelink control channel (PSCCH), a physical sidelink shared channel (PSSCH), and a physical sidelink feedback channel (PSFCH). The PSDCH carries discovery expressions that enable proximal UEs to discover each other. The PSCCH carries control signaling such as sidelink resource configurations, resource reservations, and other parameters used for data transmissions. The PSSCH carries data transmissions. The PSFCH carries a feedback such as acknowledgement (ACK) and/or negative ACK (NACK) information corresponding to transmissions on the PSSCH.

In some NR systems, a two stage sidelink control information (SCI) is supported. The two stage SCI includes a first stage SCI (e.g., SCI-1) and a second stage SCI (e.g., SCI-2). The SCI-1 includes resource reservation and allocation information. The SCI-2 includes information that can be used to decode data and to determine whether a UE is an intended recipient of a transmission. The SCI-1 and/or the SCI-2 may be transmitted over a PSCCH.

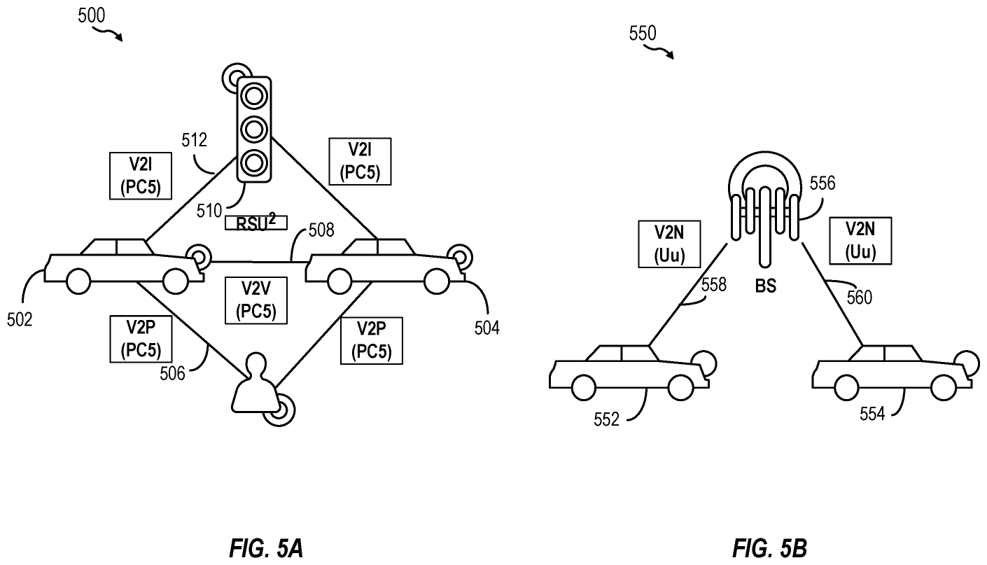

FIG. 5A and FIG. 5B show diagrammatic representations of example V2X systems. For example, vehicles shown in FIG. 5A and FIG. 5B communicate via sidelink channels and relay sidelink transmissions. V2X is a vehicular technology system that enables vehicles to communicate with traffic and an environment around them using short-range wireless signals, known as sidelink signals.

The V2X systems shown in FIG. 5A and FIG. 5B provide two complementary transmission modes. A first transmission mode, shown by way of example in FIG. 5A, involves direct communications (e.g., also referred to as sidelink communications) between participants in proximity to one another in a local area. A second transmission mode, shown by way of example in FIG. 5B, involves network communications through a network, which may be implemented over a Uu interface (for example, a wireless communication interface between a radio access network (RAN) and a UE).

Referring to FIG. 5A, a V2X system 500 (e.g., including V2V communications) is illustrated with two vehicles 502, 504. A first transmission mode allows for direct communication between different participants in a given geographic location. As illustrated, a vehicle 502 can have a wireless communication link 506 with an individual through a PC5 interface. Communications between the vehicles 502 and 504 may also occur through a PC5 interface 508. In a like manner, communication may occur from the vehicle 502 to other highway components (e.g., a roadside unit (RSU) 510), such as a traffic signal or sign through a PC5 interface 512. With respect to each communication link illustrated in FIG. 5A, two-way communication may take place between devices, therefore each device may be a transmitter and a receiver of information. The V2X system 500 is a self-managed system implemented without assistance from a network entity. A self-managed system may enable improved spectral efficiency, reduced cost, and increased reliability as network service interruptions do not occur during handover operations for moving vehicles. The V2X system 500 is configured to operate in a licensed or unlicensed spectrum, thus any vehicle with an equipped system may access a common frequency and share information. Such harmonized/common spectrum operations allow for safe and reliable operation.

FIG. 5B shows a V2X system 550 for communication between a vehicle 552 and a vehicle 554 through a network entity 556. Network communications may occur through discrete nodes, such as a network entity 556 that sends and receives information to and from (e.g., relays information between) the vehicles 552, 554. The network communications through vehicle to network (V2N) links 558 and 560 may be used, for example, for long-range communications between the vehicles 552, 554, such as for communicating the presence of a car accident a distance ahead along a road or highway. Other types of communications may be sent by a wireless node to the vehicles 552, 554, such as traffic flow conditions, road hazard warnings, environmental/weather reports, and service station availability, among other examples. Such data can be obtained from cloud-based sharing services.

### Example Vehicle-to-Everything (V2X) Focused New Radio (NR) Sidelink and Sidelink Unlicensed

One example of a sidelink scenarios is a new radio (NR) sidelink system used for vehicle-to-everything (V2X) communications to exchange short and sparse messages among vehicular user equipments (UEs) (e.g., over sub-7 GHz intelligent transport systems (ITS)/licensed bands).

In the NR sidelink system, two channel access/resource allocation modes (e.g., Mode 1 and Mode 2) are specified. The Mode 1 is specified for in-coverage deployment where a sidelink UE receives a grant from a gNodeB (gNB) for a centralized channel access. The Mode 2 is specified for autonomous deployment where a sidelink UE performs sensing-and-reservation based distributed channel access.

In some cases, sidelink resources in the NR sidelink system are arranged to support orthogonal frequency division multiple access (OFDMA) (e.g., using “subchannel x slot” as granularity). In some cases, a subchannel can be pre-configured (e.g., to be of 10 resource block (RB), 12RB, 15RB, 20RB, 25RB, 50RB, 75RB, or 100RB). Also, for a given resource pool, a relatively small subchannel size may help in suppressing collision when traffics are dominated by small transport blocks (TBs), and a rare and large TB can be carried by simultaneously transmitting over adjacent subchannels.

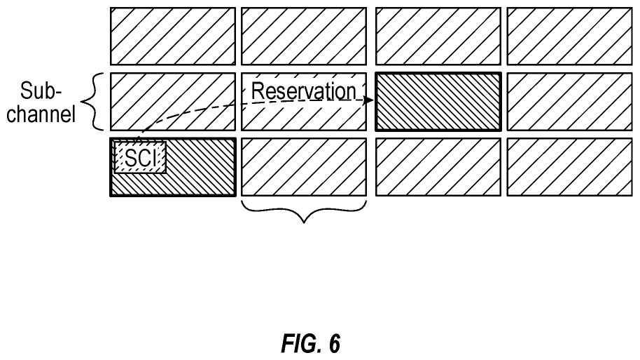

In some cases, as illustrated in FIG. 6, a sidelink UE carries a codepoint in a sidelink control information (SCI) to reserve a future sidelink resource for a retransmission (e.g., a dynamic reservation) or a new transmission (e.g., a periodical reservation). A sensing UE (e.g., when operating in the Mode 2) may decode the received SCI in its sensing window and perform collision avoidance accordingly.

In some cases, a discontinuous reception (DRX) in the NR is specified for battery-powered UEs, and inter-UE coordination is specified for a higher reliability in the Mode 2. In addition, sidelink applications have been limited to sub-7 GHz licensed/ITS bands, and not every sidelink application can access to sub-7 GHz licensed/ITS bands.

In some cases, a sidelink may be deployed over other bands. For example, the sidelink may be deployed on a frequency range 1 (FR1) unlicensed spectrum for both the Mode 1 and the Mode 2 where Uu operation for the Mode 1 is limited to a licensed spectrum (e.g., with possible scope of evaluation methodology for a sidelink operation on the unlicensed spectrum, a sidelink channel access mechanism for the unlicensed spectrum, and/or required changes to channel structures and procedures to operate on the unlicensed spectrum).

The present disclosure considers utilization of sidelink unlicensed (SL-U) over a FR1 unlicensed band with a listen before talk (LBT) procedure, and determines how to facilitate resource reservation with respect to a cyclic prefix (CP) extension (CPE) based channel access to improve spectral efficiency (e.g., especially for carrying enhanced mobile broadband (eMBB) type burst traffic).

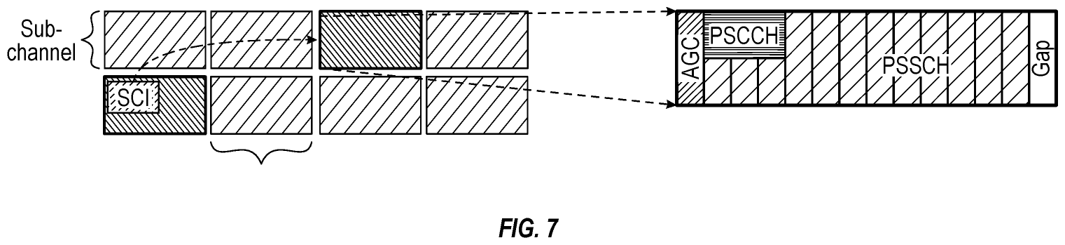

In some cases, a LBT procedure is facilitated for co-existence with other radio access technologies (RATs) to specify a NR unlicensed (NR-U). For example, reusing mechanisms are developed for intra-RAT resource allocations and performing the LBT procedure (e.g., when accessing allocated resources for inter-RAT co-existence). This leads to simultaneous transmission at a slot boundary (i.e., an automatic gain control (AGC) symbol per legacy) and simultaneously keeping silence in a last “gap” symbol (e.g., as illustrated in FIG. 7) for a channel clearance assessment (CCA). Such reusing mechanisms can be used for V2X communications.

In some cases, when a size of a subchannel is large enough for a considered TB (e.g., for carrying relatively small packets in the V2X communications), frequency division multiplexed (FDMed) subchannels can effectively reduce a probability of collisions of simultaneous channel access attempts (e.g., when system loading is moderate). Furthermore, a periodicity of the V2X communications traffic can be leveraged by a reservation mechanism to further suppress collision. However, typical eMBB traffic is neither of a small TB size nor with the periodicity.

### Aspects Related to S-SSB Based Sidelink Resource Determination

Aspects of the present disclosure provide apparatuses, methods, processing systems, and computer-readable mediums for determining sidelink resources, based on sidelink synchronization signals. The techniques presented herein may help SL devices efficiently determine available SL resources, avoiding extensive searching and the associated latency and power consumption.

As noted above, current systems rely on offline configuration of UEs or network-signaled configuration of sidelink resources, such as sidelink bandwidth parts (BWPs) or resource pools (RPs). In such systems, S-SSBs are typically only used to provide timing and TDD configuration information.

In some cases, given the SL resource reservation mechanisms described above, bits in a physical sidelink broadcast channel (PSBCH) conventionally used to convey TDD configuration information (e.g., 12 bits) may be reused to provide SL resource information, as described herein. For example, such SL resource information may include information regarding an RB grid or information regarding an RB set (e.g., including intra-cell guard band definition) for SL, so that two different UEs can have a common understanding on full duplex (FD) SL resource allocation.

The mechanisms described herein may allow SL UEs to properly communicate with each other, even absent central control. The mechanisms may be used in licensed or unlicensed spectrum, when UEs are associated with different operators, or even if one or both have no operator. In some cases, the SL-U UEs may each have their own preferred setting. In some cases, one of the SL UEs may provide SL resource parameters directly (e.g., via S-SSB transmissions) so that other SL UEs can use those parameters to talk with that particular SL UE.

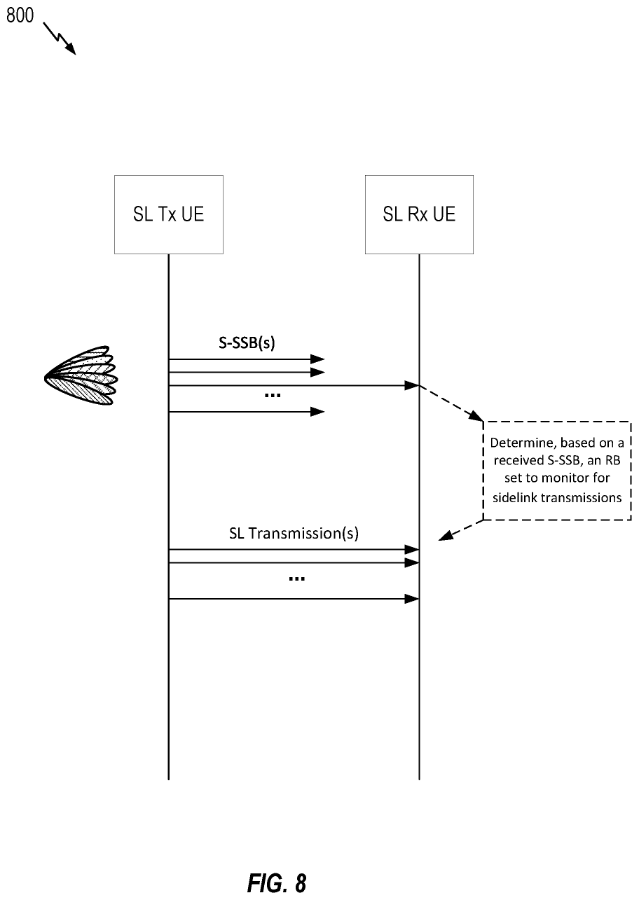

S-SSB based SL resource determination proposed herein may be understood with reference to the example call flow diagram 800 of FIG. 8.

As illustrated, a sidelink transmitter UE (SL Tx UE) may transmit S-SSBs (e.g., in different directions using different beams). The S-SSBs may be transmitted in a reference subband (e.g., a reference 20 MHz subband). A sidelink receiver UE (SL Rx UE) detecting one of the S-SSBs may determine, based on the S-SSB, an RB set for receiving sidelink transmissions from at least one other UE (e.g., the SL Tx UE that transmitted the S-SSB or another SL UE). As illustrated, the SL Rx UE may then monitor the RB set for sidelink transmissions.

The S-SSB based SL resource determination mechanisms proposed herein may be used for SL transmissions with contiguous or interlaced sidelink resource allocations. In an interlaced sidelink resource allocation, an RB grid may be defined that includes a plurality of RB sets, each partitioned into different non-contiguous groups of equally spaced RBs, referred to as interlaces.

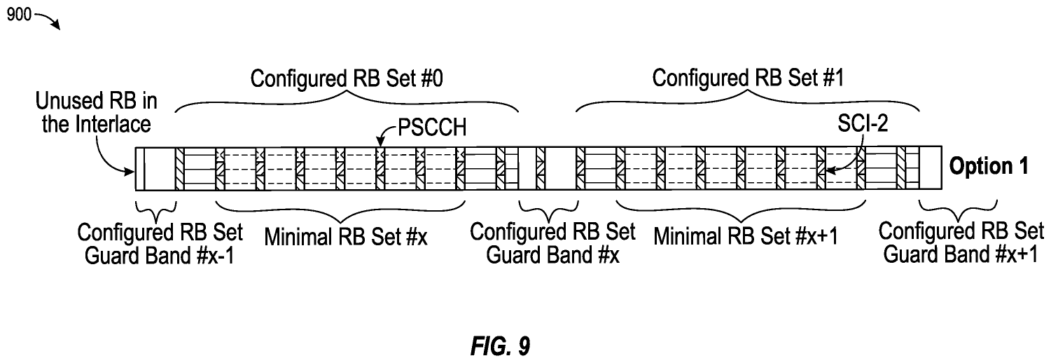

For example, as illustrated by the example RB grid 900 of FIG. 9, an interlace may be formed by ten equally spaced RBs 910. The RB grid 900 may be formed by different configured RB sets 922 and 924 (Configured RB set #0 and Configured RB set #1) that are separated by guard bands. The guard bands may be configured via the S-SSBs. RBs in the interlace may be monitored for PSSCH and sidelink control information (e.g., SCI-1 or SCI-2).

In some cases, the RB grid may be determined based on a parameter (K_SSB), conveyed in the PSBCH of the S-SSB, that indicates a frequency offset from a subcarrier of the S-SSB to a common resource block (CRB). In some cases, an initial BWP or RP may be configured in the S-SSB indicating a subband for remaining minimum system information (RMSI) or other system information blocks (SIBs), initial radio resource control (RRC) messages, or other SL transmissions (e.g., fall-back SL transmission).

Aspects of the present disclosure provide various types of RB set configurations for wideband (WB) SL transmission. A first type of RB set configuration, an S-SSB transmitter based RB-set configuration, signaled via RMSFSIB (e.g., conveyed in S-SSBs from SL Tx UE of FIG. 8), may enable a relatively simple wideband RB-set configuration for groupcast/broadcast messages. A second type of RB set configuration, referred to as a per-link RB-set configuration, may involve RRC messages exchanged between Tx and Rx SL UEs in an initial RP and may be suitable for unicast.

As illustrated in FIG. 9, in some cases, each configured RB set may include a minimal RB set in order to simplify searching. For example, SCI-1 and SCI-2 message transmissions may be rate matched in these minimal RB sets (among all possible RB set configurations) within each 20 MHz subband to allow an SL Rx UE to decode SCI-1 (in a PSCCH) and/or SCI-2 even when the RB-set configuration is unknown. In some cases, the RB set configuration for decoding PSSCH transmissions could depend on an SL Tx UE ID or some indications provided in the SCI.

In some cases, the RB grid 900 for an unlicensed band may be fixed (hard coded) an intra-cell guard bands may be hard coded for each 20 MHz subband. Unlike typical NR-U, which defines the guard band with respect to a reference frequency point, referred to as point A, in terms of a common resource block (CRB), aspects of the present disclosure may define the guard band with absolute frequencies for each 20 MHz subband in an NR-U band.

Even with hard coded RB sets, different SL nodes may still have different BWP configurations. The different BWP configurations may include different BWP bandwidth and different BWP starting RBs, though the BWPs may still be aligned with the starting frequency of an RB set.

With the common RB grid and intra-cell guard band definition, PSCCH/PSSCH may be detected relatively easily and resource allocation may be common as well. In some cases, the frequency domain resource allocation (FDRA) may be indicated in a relative manner (e.g., with reference to a configured BWP or RP).

In some cases, a PSBCH (conveyed in an S-SSB) may indicate an initial BWP and initial RP. In such cases, the S-SSB transmitter (e.g., SL Tx UE in FIG. 8) may configure the RB grid and RB set (via PSBCH) for 20 MHz sub-bands that contain S-SSBs. There are various options for RB grid configuration. According to a first option, the Master information block (MIB) in the PSBCH may be used to configure the subcarrier offset, K_SSB, from PSBCH to the RB grid. This approach allows for relatively flexible RB grid configuration from the raster. According to a second option, a fixed RB grid and a common subcarrier offset may be used. In this case, the common subcarrier offset may depend on the raster point when multiple synchronization rasters are allowed.

There are various options for RB set configuration for the initial BWP or RP. In some cases, the initial BWP or RP confined within the 20 MHz containing the S-SSB may be defined for RMSFSIB transmission and initial RRC configuration messages. In such cases, the MIB may configure the RB offset from the 0th RB of PSBCH to the 0th RB of the initial BWP and also the size of initial BWP. In other words, in this case, the MIB will configure the RB set within the 20 MHz of the S-SSB. This may be considered as similar to the configuration of NR Coreset #0 from MIB. However, as a CORESET is not used in SL-U, the PSBCH will directly indicate the initial SL BWP. Given this information, the set of RBs for each interlace may be known in the initial BWP.

As noted above, in some cases fields of a PSBCH may be reused to indicate a sidelink resource configuration. For example, some parts of the 12-bit TDD field in PSBCH may be reused to indicate a combination of parameters (e.g., RB offset and size of initial BWP), since the TDD configuration may not be important to SL-U.

In some use cases, the network (NW) may want to align the initial BWP configuration so the system messages can be communicated to all of the SL nodes (at least for in-coverage nodes and the SL nodes connected to the sync nodes which are in-coverage). In this manner, aspects of the present disclosure may allow the sync node to pass the initial BWP configuration to out-of-coverage SL nodes.

Given the flexible resource configurability proposed herein, cross node decoding (where other) may present a challenge, as a UE may detect SL resource configuration parameters transmitted from different nodes. However, in some cases, UEs may be configured to not expect to perform decoding if parameters do not match, especially if the RB grid does not match. This may help provide motivation for a transmitting node to choose to use the same set of parameters.

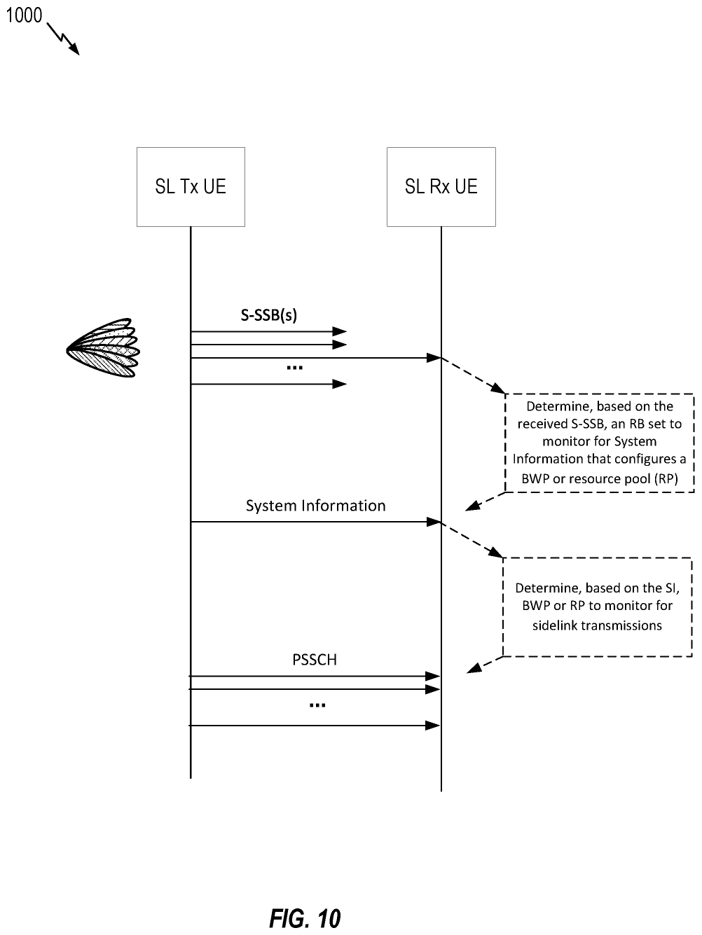

As illustrated in FIG. 10, in some cases, a wideband SL BWP or RP may be configured. As described above with reference to FIG. 9, the SL Rx UE may determine an RB set to monitor based on a detected S-SSB. The SL Rx UE may monitor this RB set for system information that configures a wideband BWP or RP (used for PSSCH transmissions).

In conventional cellular (Uu) links, for wideband operation, RMSI indicates an offset to the frequency reference point A (via a parameter offsetToPointA) and common resource block (CRB) are defined. The initial UL/DL BWP and the UE specific BWP are configured based on CRB grid. In NR-U, the intra-cell guard band are UE-specific configurations and the wideband UL BWP may need to be defined based on the intra-cell guard band configurations. Depending on a use case, S-SSB transmitter centric RB-set configurations may be used for groupcast and broadcast signaling, while per-link RB-set configurations may be used for unicast signaling.

There are various options when using a SL S-SSB to configure wideband BWP/RP/RB-sets. According to one option, a broadcast approach may be used, where RMSFSIB provides a Point A indication and conveys offsetToPointA and wideband intra-cell guard band configuration. In some use cases, all the SL nodes in NW may want to share the same point A and intra-cell guard band configuration. The S-SSB transmitting nodes help to propagate the configuration with RMSFSIB.

In some use cases, the S-SSB Txer nodes want to groupcast or broadcast a message with a wideband PSSCH transmission. In such cases, an S-SSB Txer centric wideband RB-set configuration could be useful. A simple way to send the configuration is via systems information (as shown in FIG. 10), such as RMSI or some other SIB. For this option, UE to UE wideband transmission may not need the initial RRC setup stage for the wideband configuration via initial RP. However, in some cases, the SL nodes may want to adjust bandwidth per link for unicast and may Frequency Division Multiplex (FDM) different links in different subbands.

According to another option, a UE specific signaling approach may be used to configure wideband BWP/RP/RB-sets. In such cases, RMSI/SIB may provide Point A, while offsetToPointA and WB intra-cell guard band configurations may be configured for each link. In this case, the intra-cell guard band configurations may be communicated between the SL Tx UE and the SL Rx UE via the 20 MHz initial RP, and then the WB BWP may be configured.

By providing mechanisms that may help UEs determine sidelink resources based on S-SSBs, the techniques described herein help enable SL UEs to efficiently determine resources available for SL resources without excessive searching, thus reducing corresponding latency and power consumption.

### Example Operations

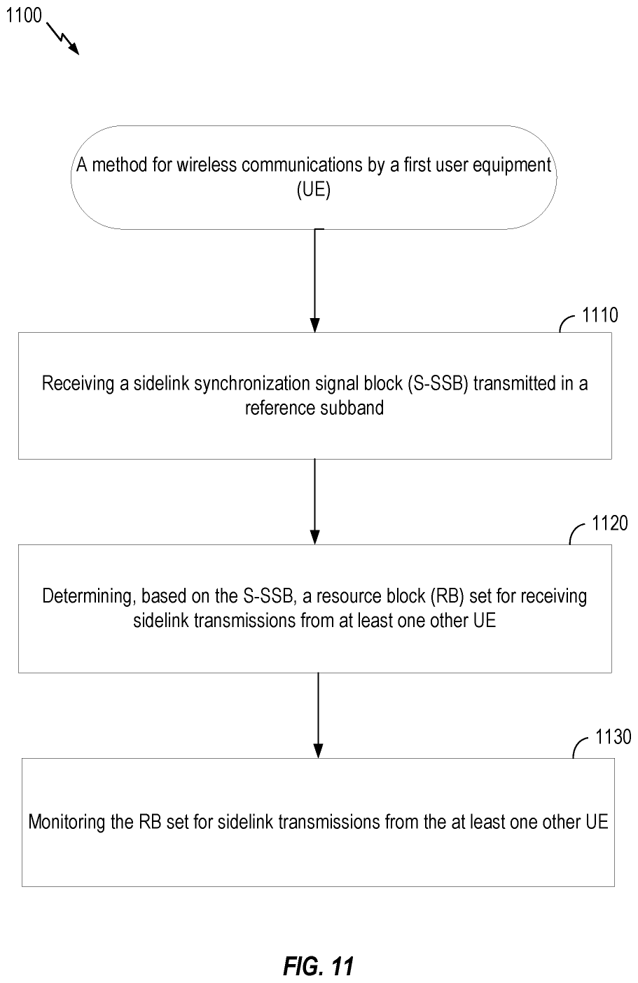

FIG. 11 shows a method 1100 for wireless communications by a first UE, such as UE 104 of FIGS. 1 and 3.

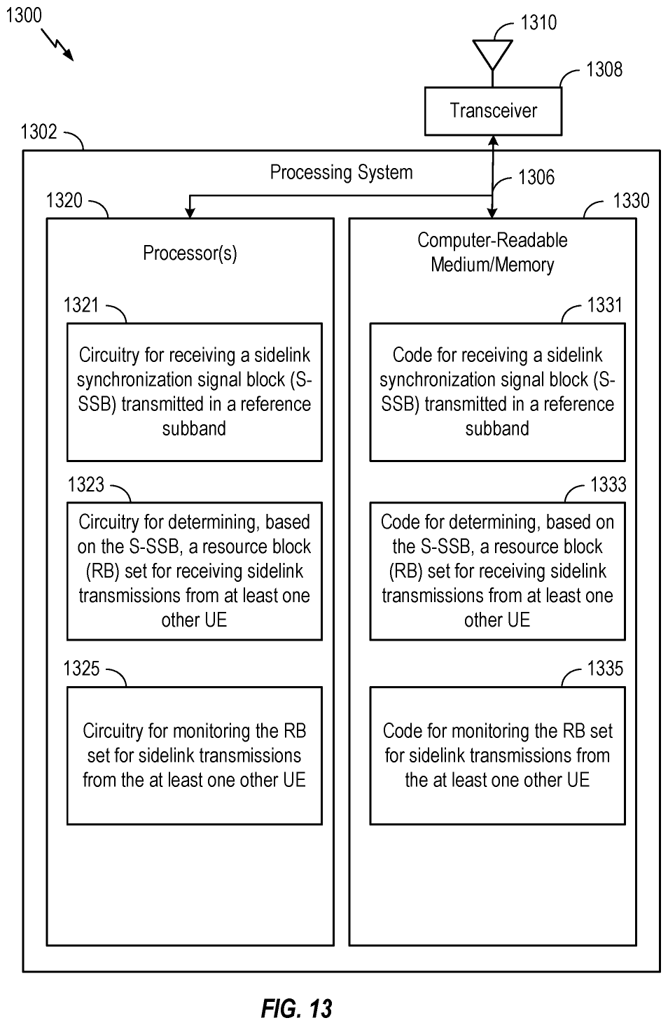

Method 1100 begins at 1105 with receiving an S-SSB transmitted in a reference subband. In some cases, the operations of this step refer to, or may be performed by, S-SSB reception circuitry as described with reference to FIG. 13.

Method 1100 then proceeds to step 1110 with determining, based on the S-SSB, a RB set for receiving sidelink transmissions from at least one other UE. In some cases, the operations of this step refer to, or may be performed by, sidelink resource processing circuitry as described with reference to FIG. 13.

Method 1100 then proceeds to step 1115 with monitoring the RB set for sidelink transmissions from the at least one other UE. In some cases, the operations of this step refer to, or may be performed by, sidelink monitoring circuitry as described with reference to FIG. 13.

Various aspects relate to the method 1100, including the following aspects.

In some aspects, the RB set comprises an interlace structure of non-contiguous RBs. In some aspects, the reference subband is located within unlicensed spectrum. In some aspects, the RB set is determined based on a parameter conveyed in the S-SSB that indicates a frequency offset from a subcarrier of the S-SSB to a CRB.

In some aspects, determining the RB set comprises: selecting the RB set from a group of pre-configured RB sets within the reference subband. In some aspects, adjacent pre-configured RB in the group are separated by defined guard bands.

In some aspects, determining the RB set comprises: determining the RB set based on one or more parameters indicated as a MIB conveyed in the S-SSB. In some aspects, the MIB is conveyed in a PSBCH. In some aspects, the one or more parameters comprise a subcarrier offset from a PBSCH that defines a configurable RB grid on which the RB set is located. In some aspects, the one or more parameters comprise a subcarrier offset that indicates a location of the RB set within a fixed RB grid.

In some aspects, the first UE determines the RB set as part of configuration of an initial BWP or an initial RP. In some aspects, monitoring the RB set for sidelink transmissions from the at least one other UE comprises: monitoring the initial BWP or the initial RP for transmissions of at least one of SI or RRC configuration messages. In some aspects, the MIB indicates a location and size of the initial BWP or the initial RP. In some aspects, the MIB indicates a location and size of the initial BWP or the initial RP via one or more bits of a TDD field.

In some aspects, monitoring the RB set for sidelink transmissions from the at least one other UE comprises monitoring the RB set for system information that configures at least one of: a wideband RB set that spans a frequency band wider than the reference subband; a wideband BWP that spans a frequency band wider than the reference subband; or a wideband RP that spans a frequency band wider than the reference subband.

In some aspects, the system information indicates a frequency offset and guard band configuration for the at least one of the wideband RB set, the wideband BWP, or the wideband RP. In some aspects, the at least one of the wideband RB set, the wideband BWP, or the wideband RP is used for unicast sidelink transmissions. In some aspects, the system information indicates a frequency offset for the at least one of the wideband RB set, the wideband BWP, or the wideband RP. In some aspects, the first UE receives per link guard band configuration for the at least one of the wideband RB set, the wideband BWP, or the wideband RP.

In one aspect, method 1100, or any aspect related to it, may be performed by an apparatus, such as communications device 1300 of FIG. 13, which includes various components operable, configured, or adapted to perform the method 1100.

Communications device 1300 is described below in further detail.

Note that FIG. 11 is just one example of a method, and other methods including fewer, additional, or alternative steps are possible consistent with this disclosure.

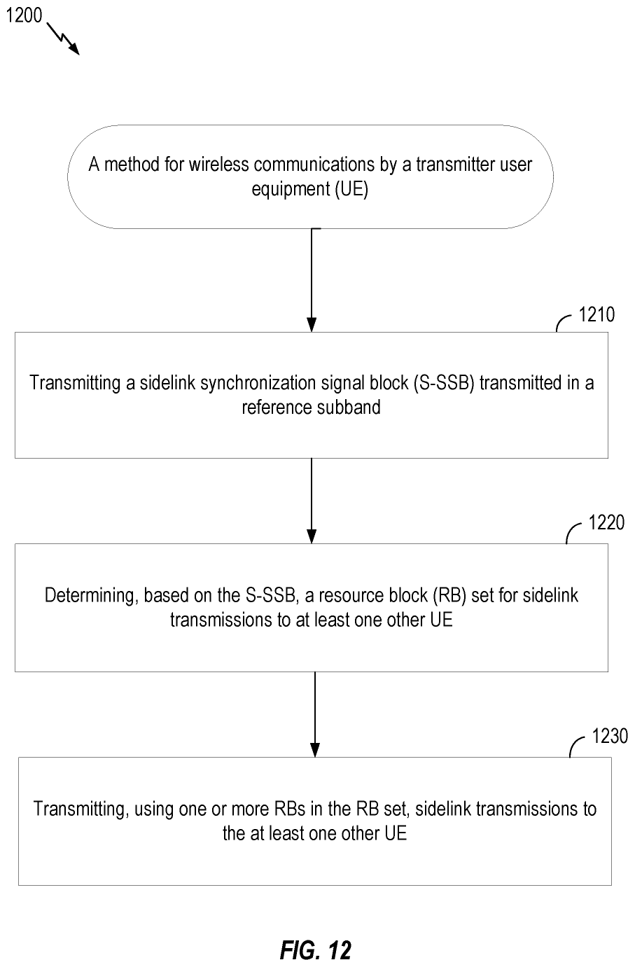

FIG. 12 shows a method 1200 for wireless communications by a transmitter UE, such as UE 104 of FIGS. 1 and 3.

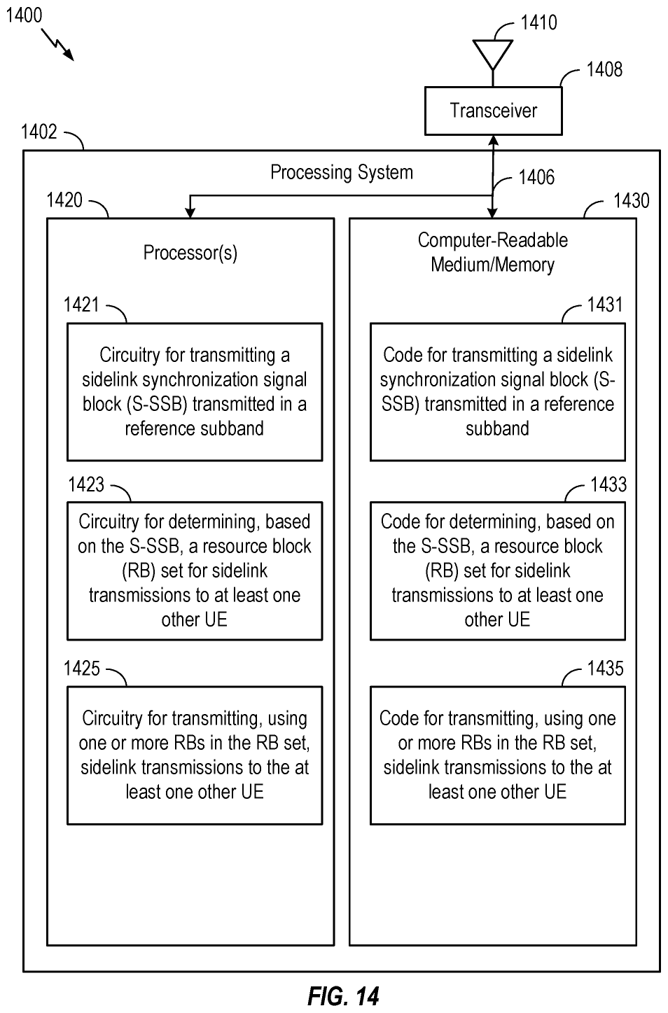

Method 1200 begins at 1205 with transmitting an S-SSB transmitted in a reference subband. In some cases, the operations of this step refer to, or may be performed by, S-SSB transmission circuitry as described with reference to FIG. 14.

Method 1200 then proceeds to step 1210 with determining, based on the S-SSB, a RB set for sidelink transmissions to at least one other UE. In some cases, the operations of this step refer to, or may be performed by, sidelink resource processing circuitry as described with reference to FIG. 14.

Method 1200 then proceeds to step 1215 with transmitting, using one or more RBs in the RB set, sidelink transmissions to the at least one other UE. In some cases, the operations of this step refer to, or may be performed by, sidelink transmission circuitry as described with reference to FIG. 14.

Various aspects relate to the method 1200, including the following aspects.

In some aspects, the RB set comprises an interlace structure of non-contiguous RBs. In some aspects, the reference subband is located within unlicensed spectrum. In some aspects, the RB set is determined based on a parameter, conveyed in the S-SSB, that indicates a frequency offset from a subcarrier of the S-SSB to a CRB.

In some aspects, determining the RB set comprises: selecting the RB set from a group of pre-configured RB sets within the reference subband. In some aspects, adjacent pre-configured RB in the group are separated by defined guard bands.

In some aspects, determining the RB set comprises determining the RB set based on one or more parameters indicated as a MIB conveyed in the S-SSB. In some aspects, the MIB is conveyed in a PSBCH. In some aspects, the one or more parameters comprise a subcarrier offset from a PBSCH that defines a configurable RB grid on which the RB set is located. In some aspects, the one or more parameters comprise a subcarrier offset that indicates a location of the RB set within a fixed RB grid.

In some aspects, the transmitter UE determines the RB set as part of configuration of an initial BWP or an initial RP. In some aspects, the transmitting the sidelink transmissions to the at least one other UE comprises: transmitting, on the initial BWP or the initial RP, at least one of SI or RRC configuration messages.

In some aspects, the MIB indicates a location and size of the initial BWP or the initial RP. In some aspects, the MIB indicates a location and size of the initial BWP or the initial RP via one or more bits of a TDD field.

In some aspects, the transmitting the sidelink transmissions to the at least one other UE comprises transmitting system information that configures at least one of: a wideband RB set that spans a frequency band wider than the reference subband; a wideband BWP that spans a frequency band wider than the reference subband; or a wideband RP that spans a frequency band wider than the reference subband.

In some aspects, the system information indicates a frequency offset and guard band configuration for the at least one of the wideband RB set, the wideband BWP, or the wideband RP.

In some aspects, the transmitter UE uses the at least one of the wideband RB set, the wideband BWP, or the wideband RP for unicast sidelink transmissions. In some aspects, the system information indicates a frequency offset for the at least one of the wideband RB set, the wideband BWP, or the wideband RP. In some aspects, the transmitter UE transmits, to at least one other UE, per link guard band configuration for the at least one of the wideband RB set, the wideband BWP, or the wideband RP.

In one aspect, method 1200, or any aspect related to it, may be performed by an apparatus, such as communications device 1400 of FIG. 14, which includes various components operable, configured, or adapted to perform the method 1200.

Communications device 1400 is described below in further detail.

Note that FIG. 12 is just one example of a method, and other methods including fewer, additional, or alternative steps are possible consistent with this disclosure.

### Example Communications Devices

FIG. 13 depicts aspects of an example communications device 1300. In some aspects, communications device 1300 is a first user equipment, such as UE 104 described above with respect to FIGS. 1 and 3.

The communications device 1300 includes a processing system 1305 coupled to the transceiver 1355 (e.g., a transmitter and/or a receiver). The transceiver 1355 is configured to transmit and receive signals for the communications device 1300 via the antenna 1360, such as the various signals as described herein. The processing system 1305 may be configured to perform processing functions for the communications device 1300, including processing signals received and/or to be transmitted by the communications device 1300.

The processing system 1305 includes one or more processors 1310. In various aspects, the one or more processors 1310 may be representative of one or more of receive processor 358, transmit processor 364, TX MIMO processor 366, and/or controller/processor 380, as described with respect to FIG. 3. The one or more processors 1310 are coupled to a computer-readable medium/memory 1330 via a bus 1350. In certain aspects, the computer-readable medium/memory 1330 is configured to store instructions (e.g., computer-executable code) that when executed by the one or more processors 1310, cause the one or more processors 1310 to perform the method 1100 described with respect to FIG. 11, or any aspect related to it. Note that reference to a processor performing a function of communications device 1300 may include one or more processors 1310 performing that function of communications device 1300.

In the depicted example, computer-readable medium/memory 1330 stores code (e.g., executable instructions), such as S-SSB reception code 1335, sidelink resource processing code 1340, and sidelink monitoring code 1345. Processing of the S-SSB reception code 1335, sidelink resource processing code 1340, and sidelink monitoring code 1345 may cause the communications device 1300 to perform the method 1100 described with respect to FIG. 11, or any aspect related to it.

The one or more processors 1310 include circuitry configured to implement (e.g., execute) the code stored in the computer-readable medium/memory 1330, including circuitry such as S-SSB reception circuitry 1315, sidelink resource processing circuitry 1320, and sidelink monitoring circuitry 1325. Processing with S-SSB reception circuitry 1315, sidelink resource processing circuitry 1320, and sidelink monitoring circuitry 1325 may cause the communications device 1300 to perform the method 1100 described with respect to FIG. 11, or any aspect related to it.

Various components of the communications device 1300 may provide means for performing the method 1100 described with respect to FIG. 11, or any aspect related to it. For example, means for transmitting, sending or outputting for transmission may include transceivers 354 and/or antenna(s) 352 of the UE 104 illustrated in FIG. 3 and/or the transceiver 1355 and the antenna 1360 of the communications device 1300 in FIG. 13. Means for receiving or obtaining may include transceivers 354 and/or antenna(s) 352 of the UE 104 illustrated in FIG. 3 and/or the transceiver 1355 and the antenna 1360 of the communications device 1300 in FIG. 13.

According to some aspects, S-SSB reception circuitry 1315 receives a S-SSB transmitted in a reference subband. According to some aspects, sidelink resource processing circuitry 1320 determines, based on the S-SSB, a RB set for receiving sidelink transmissions from at least one other UE. According to some aspects, sidelink monitoring circuitry 1325 monitors the RB set for sidelink transmissions from the at least one other UE.

In some aspects, the RB set comprises an interlace structure of non-contiguous RBs. In some aspects, the reference subband is located within unlicensed spectrum. In some aspects, the RB set is determined based on a parameter, conveyed in the S-SSB, that indicates a frequency offset from a subcarrier of the S-SSB to a CRB. In some aspects, determining the RB set comprises: sidelink resource processing circuitry 1320 selecting the RB set from a group of pre-configured RB sets within the reference subband. In some aspects, adjacent pre-configured RB in the group are separated by defined guard bands. In some aspects, determining the RB set comprises: sidelink resource processing circuitry 1320 determining the RB set based on one or more parameters indicated as a MIB conveyed in the S-SSB. In some aspects, the MIB is conveyed in a PSBCH.

In some aspects, the one or more parameters comprise a subcarrier offset from a PBSCH that defines a configurable RB grid on which the RB set is located. In some aspects, the one or more parameters comprise a subcarrier offset that indicates a location of the RB set within a fixed RB grid. In some aspects, the first UE determines the RB set as part of configuration of an initial BWP or an initial RP. In some aspects, monitoring the RB set for sidelink transmissions from the at least one other UE comprises: sidelink monitoring circuitry 1325 monitoring the initial BWP or the initial RP for transmissions of at least one of SI or RRC configuration messages. In some aspects, the MIB indicates a location and size of the initial BWP or the initial RP. In some aspects, the MIB indicates a location and size of the initial BWP or the initial RP via one or more bits of a TDD field. In some aspects, monitoring the RB set for sidelink transmissions from the at least one other UE comprises sidelink monitoring circuitry 1325 monitoring the RB set for system information that configures at least one of: a wideband RB set that spans a frequency band wider than the reference subband; a wideband BWP that spans a frequency band wider than the reference subband; or a wideband RP that spans a frequency band wider than the reference subband. In some aspects, the system information indicates a frequency offset and guard band configuration for the at least one of the wideband RB set, the wideband BWP, or the wideband RP. In some aspects, the at least one of the wideband RB set, the wideband BWP, or the wideband RP is used for unicast sidelink transmissions. In some aspects, the system information indicates a frequency offset for the at least one of the wideband RB set, the wideband BWP, or the wideband RP. In some aspects, the first UE receives per link guard band configuration for the at least one of the wideband RB set, the wideband BWP, or the wideband RP.

FIG. 14 depicts aspects of an example communications device 1400. In some aspects, communications device 1400 is a transmitter user equipment, such as UE 104 described above with respect to FIGS. 1 and 3.

The communications device 1400 includes a processing system 1405 coupled to the transceiver 1455 (e.g., a transmitter and/or a receiver). The transceiver 1455 is configured to transmit and receive signals for the communications device 1400 via the antenna 1460, such as the various signals as described herein. The processing system 1405 may be configured to perform processing functions for the communications device 1400, including processing signals received and/or to be transmitted by the communications device 1400.

The processing system 1405 includes one or more processors 1410. In various aspects, the one or more processors 1410 may be representative of one or more of receive processor 358, transmit processor 364, TX MIMO processor 366, and/or controller/processor 380, as described with respect to FIG. 3. The one or more processors 1410 are coupled to a computer-readable medium/memory 1430 via a bus 1450. In certain aspects, the computer-readable medium/memory 1430 is configured to store instructions (e.g., computer-executable code) that when executed by the one or more processors 1410, cause the one or more processors 1410 to perform the method 1200 described with respect to FIG. 12, or any aspect related to it. Note that reference to a processor performing a function of communications device 1400 may include one or more processors 1410 performing that function of communications device 1400.

In the depicted example, computer-readable medium/memory 1430 stores code (e.g., executable instructions), such as S-SSB transmission code 1435, sidelink resource processing code 1440, and sidelink transmission code 1445. Processing of the S-SSB transmission code 1435, sidelink resource processing code 1440, and sidelink transmission code 1445 may cause the communications device 1400 to perform the method 1200 described with respect to FIG. 12, or any aspect related to it.

The one or more processors 1410 include circuitry configured to implement (e.g., execute) the code stored in the computer-readable medium/memory 1430, including circuitry such as S-SSB transmission circuitry 1415, sidelink resource processing circuitry 1420, and sidelink transmission circuitry 1425. Processing with S-SSB transmission circuitry 1415, sidelink resource processing circuitry 1420, and sidelink transmission circuitry 1425 may cause the communications device 1400 to perform the method 1200 described with respect to FIG. 12, or any aspect related to it.

Various components of the communications device 1400 may provide means for performing the method 1200 described with respect to FIG. 12, or any aspect related to it. For example, means for transmitting, sending or outputting for transmission may include transceivers 354 and/or antenna(s) 352 of the UE 104 illustrated in FIG. 3 and/or the transceiver 1455 and the antenna 1460 of the communications device 1400 in FIG. 14. Means for receiving or obtaining may include transceivers 354 and/or antenna(s) 352 of the UE 104 illustrated in FIG. 3 and/or the transceiver 1455 and the antenna 1460 of the communications device 1400 in FIG. 14.

According to some aspects, S-SSB transmission circuitry 1415 transmits a S-SSB transmitted in a reference subband. According to some aspects, sidelink resource processing circuitry 1420 determines, based on the S-SSB, a RB set for sidelink transmissions to at least one other UE. According to some aspects, sidelink transmission circuitry 1425 transmits, using one or more RBs in the RB set, sidelink transmissions to the at least one other UE.

In some aspects, the RB set comprises an interlace structure of non-contiguous RBs. In some aspects, the reference subband is located within unlicensed spectrum. In some aspects, the RB set is determined based on a parameter, conveyed in the S-SSB, that indicates a frequency offset from a subcarrier of the S-SSB to a CRB. In some aspects, determining the RB set comprises sidelink resource processing circuitry 1420 selecting the RB set from a group of pre-configured RB sets within the reference subband. In some aspects, adjacent pre-configured RB in the group are separated by defined guard bands. In some aspects, determining the RB set comprises sidelink resource processing circuitry 1420 determining the RB set based on one or more parameters indicated as a MIB conveyed in the S-SSB. In some aspects, the MIB is conveyed in a PSBCH. In some aspects, the one or more parameters comprise a subcarrier offset from a PBSCH that defines a configurable RB grid on which the RB set is located. In some aspects, the one or more parameters comprise a subcarrier offset that indicates a location of the RB set within a fixed RB grid.

In some aspects, the transmitter UE determines the RB set as part of configuration of an initial BWP or an initial RP. In some aspects, the transmitting the sidelink transmissions to the at least one other UE comprises sidelink transmission circuitry 1425 transmitting, on the initial BWP or the initial RP, at least one of SI or RRC configuration messages. In some aspects, the MIB indicates a location and size of the initial BWP or the initial RP. In some aspects, the MIB indicates a location and size of the initial BWP or the initial RP via one or more bits of a TDD field. In some aspects, the transmitting the sidelink transmissions to the at least one other UE comprises sidelink transmission circuitry 1425 transmitting system information that configures at least one of: a wideband RB set that spans a frequency band wider than the reference subband; a wideband BWP that spans a frequency band wider than the reference subband; or a wideband RP that spans a frequency band wider than the reference subband.

In some aspects, the system information indicates a frequency offset and guard band configuration for the at least one of the wideband RB set, the wideband BWP, or the wideband RP. In some aspects, the transmitter UE uses the at least one of the wideband RB set, the wideband BWP, or the wideband RP for unicast sidelink transmissions. In some aspects, the system information indicates a frequency offset for the at least one of the wideband RB set, the wideband BWP, or the wideband RP. In some aspects, the transmitter UE transmits, to at least one other UE, per link guard band configuration for the at least one of the wideband RB set, the wideband BWP, or the wideband RP.

### Example Clauses

Implementation examples are described in the following numbered clauses:

Clause 1: A method for wireless communication by a first UE, comprising: receiving a S-SSB transmitted in a reference subband; determining, based on the S-SSB, a RB set for receiving sidelink transmissions from at least one other UE; and monitoring the RB set for sidelink transmissions from the at least one other UE.

Clause 2: The method of Clause 1, wherein the RB set comprises an interlace structure of non-contiguous RBs.

Clause 3: The method of any one of Clauses 1 and 2, wherein the reference subband is located within unlicensed spectrum.

Clause 4: The method of any one of Clauses 1-3, wherein the RB set is determined based on a parameter, conveyed in the S-SSB, that indicates a frequency offset from a subcarrier of the S-SSB to a CRB.

Clause 5: The method of any one of Clauses 1-4, wherein determining the RB set comprises: selecting the RB set from a group of pre-configured RB sets within the reference subband.

Clause 6: The method of Clause 5, wherein adjacent pre-configured RB in the group are separated by defined guard bands.

Clause 7: The method of any one of Clauses 1-6, wherein determining the RB set comprises: determining the RB set based on one or more parameters indicated as a MIB conveyed in the S-SSB.

Clause 8: The method of Clause 7, wherein the MIB is conveyed in a PSBCH. In some aspects, the one or more parameters comprise a subcarrier offset from a PBSCH that defines a configurable RB grid on which the RB set is located.

Clause 9: The method of Clause 7, wherein the one or more parameters comprise a subcarrier offset that indicates a location of the RB set within a fixed RB grid.

Clause 10: The method of Clause 7, wherein the first UE determines the RB set as part of configuration of an initial BWP or an initial RP. In some aspects, monitoring the RB set for sidelink transmissions from the at least one other UE comprises: monitoring the initial BWP or the initial RP for transmissions of at least one of SI or RRC configuration messages.

Clause 11: The method of Clause 10, wherein the MIB indicates a location and size of the initial BWP or the initial RP.

Clause 12: The method of Clause 10, wherein the MIB indicates a location and size of the initial BWP or the initial RP via one or more bits of a TDD field.

Clause 13: The method of any one of Clauses 1-12, wherein monitoring the RB set for sidelink transmissions from the at least one other UE comprises monitoring the RB set for system information that configures at least one of: a wideband RB set that spans a frequency band wider than the reference subband; a wideband BWP that spans a frequency band wider than the reference subband; or a wideband RP that spans a frequency band wider than the reference subband.

Clause 14: The method of Clause 13, wherein the system information indicates a frequency offset and guard band configuration for the at least one of the wideband RB set, the wideband BWP, or the wideband RP.

Clause 15: The method of Clause 13, wherein the at least one of the wideband RB set, the wideband BWP, or the wideband RP is used for unicast sidelink transmissions. In some aspects, the system information indicates a frequency offset for the at least one of the wideband RB set, the wideband BWP, or the wideband RP. In some aspects, the first UE receives per link guard band configuration for the at least one of the wideband RB set, the wideband BWP, or the wideband RP.

Clause 16: A method for wireless communication by a transmitter UE, comprising: transmitting a S-SSB transmitted in a reference subband; determining, based on the S-SSB, a RB set for sidelink transmissions to at least one other UE; and transmitting, using one or more RBs in the RB set, sidelink transmissions to the at least one other UE.

Clause 17: The method of Clause 16, wherein the RB set comprises an interlace structure of non-contiguous RBs.

Clause 18: The method of any one of Clauses 16 and 17, wherein the reference subband is located within unlicensed spectrum.

Clause 19: The method of any one of Clauses 16-18, wherein the RB set is determined based on a parameter, conveyed in the S-SSB, that indicates a frequency offset from a subcarrier of the S-SSB to a CRB.

Clause 20: The method of any one of Clauses 16-19, wherein determining the RB set comprises: selecting the RB set from a group of pre-configured RB sets within the reference subband.

Clause 21: The method of Clause 20, wherein adjacent pre-configured RB in the group are separated by defined guard bands.

Clause 22: The method of any one of Clauses 16-21, wherein determining the RB set comprises determining the RB set based on one or more parameters indicated as a MIB conveyed in the S-SSB.

Clause 23: The method of Clause 22, wherein the MIB is conveyed in a PSBCH. In some aspects, the one or more parameters comprise a subcarrier offset from a PBSCH that defines a configurable RB grid on which the RB set is located.

Clause 24: The method of Clause 22, wherein the one or more parameters comprise a subcarrier offset that indicates a location of the RB set within a fixed RB grid.

Clause 25: The method of Clause 22, wherein the transmitter UE determines the RB set as part of configuration of an initial BWP or an initial RP. In some aspects, the transmitting the sidelink transmissions to the at least one other UE comprises: transmitting, on the initial BWP or the initial RP, at least one of SI or RRC configuration messages.

Clause 26: The method of Clause 25, wherein the MIB indicates a location and size of the initial BWP or the initial RP.

Clause 27: The method of Clause 25, wherein the MIB indicates a location and size of the initial BWP or the initial RP via one or more bits of a TDD field.

Clause 28: The method of any one of Clauses 16-27, wherein the transmitting the sidelink transmissions to the at least one other UE comprises transmitting system information that configures at least one of: a wideband RB set that spans a frequency band wider than the reference subband; a wideband BWP that spans a frequency band wider than the reference subband; or a wideband RP that spans a frequency band wider than the reference subband.

Clause 29: The method of Clause 28, wherein the system information indicates a frequency offset and guard band configuration for the at least one of the wideband RB set, the wideband BWP, or the wideband RP.

Clause 30: The method of Clause 28, wherein the transmitter UE uses the at least one of the wideband RB set, the wideband BWP, or the wideband RP for unicast sidelink transmissions. In some aspects, the system information indicates a frequency offset for the at least one of the wideband RB set, the wideband BWP, or the wideband RP. In some aspects, the transmitter UE transmits, to at least one other UE, per link guard band configuration for the at least one of the wideband RB set, the wideband BWP, or the wideband RP.

Clause 31: A processing system, comprising: a memory comprising computer-executable instructions; one or more processors configured to execute the computer-executable instructions and cause the processing system to perform a method in accordance with any one of Clauses 1-30.

Clause 32: A processing system, comprising means for performing a method in accordance with any one of Clauses 1-30.

Clause 33: A non-transitory computer-readable medium comprising computer-executable instructions that, when executed by one or more processors of a processing system, cause the processing system to perform a method in accordance with any one of Clauses 1-30.

Clause 34: A computer program product embodied on a computer-readable storage medium comprising code for performing a method in accordance with any one of Clauses 1-30.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of wireless communication by a first user equipment (UE), comprising:
receiving a sidelink synchronization signal block (S-SSB) transmitted in a reference subband;
determining, based on the S-SSB, a resource block (RB) set for receiving sidelink transmissions from at least one other UE; and
monitoring the RB set for sidelink transmissions from the at least one other UE.

2. The method of claim 1, wherein the RB set comprises an interlace structure of non-contiguous RBs.

3. The method of claim 1, wherein the reference subband is located within unlicensed spectrum.

4. The method of claim 1, wherein the RB set is determined based on a parameter, conveyed in the S-SSB, that indicates a frequency offset from a subcarrier of the S-SSB to a common resource block (CRB).

5. The method of claim 1, wherein determining the RB set comprises:
selecting the RB set from a group of pre-configured RB sets within the reference subband.

6. The method of claim 5, wherein adjacent pre-configured RB in the group are separated by defined guard bands.

7. The method of claim 1, wherein determining the RB set comprises:
determining the RB set based on one or more parameters indicated as a master information block (MIB) conveyed in the S-SSB.

8. The method of claim 7, wherein:
the MIB is conveyed in a physical sidelink broadcast channel (PSBCH); and
the one or more parameters comprise a subcarrier offset from a PBSCH that defines a configurable RB grid on which the RB set is located.

9. The method of claim 7, wherein the one or more parameters comprise a subcarrier offset that indicates a location of the RB set within a fixed RB grid.

10. The method of claim 7, wherein:
the first UE determines the RB set as part of configuration of an initial bandwidth part (BWP) or an initial resource pool (RP); and
monitoring the RB set for sidelink transmissions from the at least one other UE comprises monitoring the initial BWP or the initial RP for transmissions of at least one of system information (SI) or radio resource configuration (RRC) configuration messages.

11. The method of claim 10, wherein the MIB indicates a location and size of the initial BWP or the initial RP.

12. The method of claim 10, wherein the MIB indicates a location and size of the initial BWP or the initial RP via one or more bits of a time division duplex (TDD) field.

13. The method of claim 1, wherein:
monitoring the RB set for sidelink transmissions from the at least one other UE comprises monitoring the RB set for system information that configures at least one of:
a wideband RB set that spans a frequency band wider than the reference subband;
a wideband bandwidth part (BWP) that spans a frequency band wider than the reference subband; or
a wideband resource pool (RP) that spans a frequency band wider than the reference subband.

14. The method of claim 13, wherein:
the system information indicates a frequency offset and guard band configuration for the at least one of the wideband RB set, the wideband BWP, or the wideband RP.

15. The method of claim 13, wherein:
the at least one of the wideband RB set, the wideband BWP, or the wideband RP is used for unicast sidelink transmissions;
the system information indicates a frequency offset for the at least one of the wideband RB set, the wideband BWP, or the wideband RP; and
the first UE receives per link guard band configuration for the at least one of the wideband RB set, the wideband BWP, or the wideband RP.

16. A method of wireless communication by a transmitter user equipment (UE), comprising:
transmitting a sidelink synchronization signal block (S-SSB) transmitted in a reference subband; and
determining, based on the S-SSB, a resource block (RB) set for sidelink transmissions to at least one other UE; and
transmitting, using one or more RBs in the RB set, sidelink transmissions to the at least one other UE.

17. The method of claim 16, wherein the RB set comprises an interlace structure of non-contiguous RBs.

18. The method of claim 16, wherein the reference subband is located within unlicensed spectrum.

19. The method of claim 16, wherein the RB set is determined based on a parameter, conveyed in the S-SSB, that indicates a frequency offset from a subcarrier of the S-SSB to a common resource block (CRB).

20. The method of claim 16, wherein determining the RB set comprises:
selecting the RB set from a group of pre-configured RB sets within the reference subband.

21. The method of claim 20, wherein adjacent pre-configured RB in the group are separated by defined guard bands.

22. The method of claim 16, wherein determining the RB set comprises:
determining the RB set based on one or more parameters indicated as a master information block (MIB) conveyed in the S-SSB.

23. The method of claim 22, wherein:
the MIB is conveyed in a physical sidelink broadcast channel (PSBCH); and
the one or more parameters comprise a subcarrier offset from a PBSCH that defines a configurable RB grid on which the RB set is located.

24. The method of claim 22, wherein the one or more parameters comprise a subcarrier offset that indicates a location of the RB set within a fixed RB grid.

25. The method of claim 22, wherein:
the transmitter UE determines the RB set as part of configuration of an initial bandwidth part (BWP) or an initial resource pool (RP); and
transmitting the sidelink transmissions to the at least one other UE comprises transmitting, on the initial BWP or the initial RP, at least one of system information (SI) or radio resource configuration (RRC) configuration messages.

26. The method of claim 25, wherein the MIB indicates a location and size of the initial BWP or the initial RP.

27. The method of claim 25, wherein the MIB indicates a location and size of the initial BWP or the initial RP via one or more bits of a time division duplex (TDD) field.

28. The method of claim 16, wherein:
transmitting the sidelink transmissions to the at least one other UE comprises transmitting system information that configures at least one of:
a wideband RB set that spans a frequency band wider than the reference subband;
a wideband bandwidth part (BWP) that spans a frequency band wider than the reference subband; or
a wideband resource pool (RP) that spans a frequency band wider than the reference subband.

29. The method of claim 28, wherein:
the system information indicates a frequency offset and guard band configuration for the at least one of the wideband RB set, the wideband BWP, or the wideband RP.

30. The method of claim 28, wherein:
the transmitter UE uses the at least one of the wideband RB set, the wideband BWP, or the wideband RP for unicast sidelink transmissions;
the system information indicates a frequency offset for the at least one of the wideband RB set, the wideband BWP, or the wideband RP; and
the transmitter UE transmits, at least one other UE, per link guard band configuration for the at least one of the wideband RB set, the wideband BWP, or the wideband RP.
